(19) United States
(12) Patent Application Publication
(10) Pub. No.: US 2024/0342692 A1
(43) Pub. Date: Oct. 17, 2024

(54) Bifunctional Additive for More Low-Carbon Olefins and Less Slurry and Its Preparation Method and Application Thereof

(71) Applicant: REZEL CATALYSTS (SHANGHAI) CO., LTD., Shanghai (CN)

(72) Inventors: Runsheng ZHUO, Leshan (CN); Zongbo SHI, Leshan (CN); Xinsheng LIU, Leshan (CN); Zesong HU, Leshan (CN); Qing ZHANG, Leshan (CN)

(21) Appl. No.: 18/748,341

(22) Filed: Jun. 20, 2024

Related U.S. Application Data
(63) Continuation of application No. 17/056,427, filed on Nov. 18, 2020.

(51) Int. Cl. B01J 29/08; B01J 29/40; B01J 29/70; B01J 29/80; B01J 35/61; B01J 37/00; B01J 37/02; B01J 37/08; C10G 11/05

(52) U.S. Cl. CPC B01J 29/088; B01J 29/40; B01J 29/7007; B01J 29/80; B01J 35/613; B01J 37/0018; B01J 37/0201; B01J 37/08; C10G 11/05; B01J 2229/18

(57) ABSTRACT

The invention discloses a bifunctional additive for increasing low-carbon olefins and reducing slurry in cracking product, wherein the dry-basis components of said additive is as follows: 40˜55 wt % of phosphorus-containing MFI zeolite, 0˜10 wt % of large pore type Y and Beta zeolites, 3˜20 wt % of inorganic binder, 8˜22 wt % of inorganic matrix composed of alumina and amorphous silica-alumina and 15˜40 wt % of clay. The bifunctional additive is mainly used to facilitate production rate of cracked LPG and increase concentration of propylene in LPG and octane number of produced the gasoline, and at the same time reduce the yield of slurry in the cracking products. The invention also discloses its preparation method and application of said additive.

### CROSS REFERENCE TO RELATED APPLICATION

This application is a continuation of U.S. patent application Ser. No. 17/056,427, filed on Nov. 18, 2020, and the entire contents of which are incorporated herein by reference.

### FIELD OF THE INVENTION

The invention relates to petroleum refining, in particularly, the invention relates to a novel additive, the method of making and using the same in catalytic cracking to produce more low-carbon olefins and less slurry in cracking products.

### BACKGROUND

Fluid catalytic cracking (FCC), as an important process for petroleum refining, is an important means to improve the economic benefits in a refinery plant. In the FCC process, heavy oil can be, with catalyst, converted into such products as gasoline, diesel, ethylene, propylene, butylene, slurry, dry gas and coke, wherein gasoline, diesel, ethylene, propylene and butylene have higher economic value, while dry gas, slurry and coke have lower economic value.

Low-carbon olefins mainly include ethylene, propylene and butylene. They are petrochemical raw materials and their demand is increasing year by year. The FCC process is the important source of low-carbon olefins, and adding low-carbon olefins additives to the cracking device is an important way to producing more low-carbon olefins. CN101450321 discloses an additive for producing more propylene, wherein said additive is prepared with anticoagulant polymerization inhibitor, and in the process silica binder is added in two steps, so that said additive features good capability of producing more propylene, more resistance to wear and lower bulk density. An additive to increase yield of low-carbon olefins in cracking is also disclosed in CN103007988A, wherein said additive use phosphorus-alumina binder and phosphorus-containing shape-selective zeolite modified with one or more of transition metal oxides. The said additive can increase the yield of propylene in LPG, and reduce the yields of coke and dry gas. An additive to increase yields of low-carbon olefins in cracking is disclosed in CN103785457A, wherein the said additive has β zeolite containing phosphorus and transition metal oxides, which, upon using, increases the yields of propylene and isobutylene in LPG, and increases the yield of ethylene in dry gas. An additive to increase octane number in cracked gasoline is disclosed in CN102851058 A, wherein the said additive contains ZSM-5 zeolite with silica/alumina molar ratio of 30˜150, and the zeolite is modified with metal elements. An additive containing phosphorus-containing Beta zeolite for FCC process is disclosed in CN107971000A, wherein the phosphorus-containing Beta zeolite has Al distribution parameter (the ratio of surface aluminum content to center aluminum content of crystalline zeolite particle) ranged 0.4˜0.8, micropore specific surface area within 420˜520 m²/g, and mesopore to total pore volume ratio of 30˜70 wt %. In the current market, low-carbon olefins additives are mostly used to convert hydrocarbons with longer chains to low-carbon olefins such as propylene using shape-selective zeolites. However, this kind of additive generally has lower cracking activity, and when added to FCC unit, it lowers the overall activity of catalyst and increases yield of slurry.

As the crude oil is getting heavier and heavier, yield of slurry in FCC process is increasing. For making up of the deficiency with the traditional catalyst for FCC process, adding additive to FCC catalyst is an important way to produce more gasoline, diesel and LPG, and reduce slurry. A slurry additive is disclosed in WO97/12011, wherein the said additive mainly comprises alumina, amorphous alumina-silica and zeolite, and the said additive significantly improves cracking capability of slurry. A slurry additive for FCC process is disclosed in CN107376986A, wherein the said additive comprises zeolite, matrix, active metallic substances, inactive metallic substances and promoters. The said additive, by means of a synergetic effect with the active and inactive metallic substances, optimizes the number of acid sites and the strength of the acid sites of the catalyst, thereby improving slurry catalytic cracking capability. Such system exhibits excellent resistance to contaminants and hydrothermal stability. A slurry additive for FCC process is disclosed in CN101745373B, wherein the said additive includes hierarchical alumina and improves cracking capability of heavy oil and yield of light oil with good coke selectivity. A slurry additive for FCC process is disclosed in CN102974331B, wherein the said additive is made of with mesoporous silica-alumina materials and cracking capability of heavy oil and yield of light oil are improved. A slurry additive for FCC process is disclosed in CN104588051B, wherein the said additive uses active mesoporous materials and alumina-phosphorus component as raw materials. The additive so prepared has better heavy oil cracking capability, light oil yield and coke selectivity. A highly active catalyst is disclosed in U.S. Pat. No. 7,101,473B2, wherein the said catalyst is prepared through in-situ crystallization which provides higher zeolite content. The catalyst effectively reduces slurry yield.

In summary, the above-mentioned slurry additives are mainly trying to improve cracking activities of catalysts via addition of additives, reduce slurry yields via increasing content of mesopores and macropores in additives, and improve acidity of matrix or via increase zeolite content to enhance cracking.

### Technical Problem

The currently available additives for producing more low-carbon olefins and generating less slurry in catalytic cracking can only function as individually designed. The additives which intend to produce more low-carbon olefins generally do not reduce slurry yield and the additives which intend to reduce slurry do not produce more low-carbon olefins. Few reports have been disclosed about additives in FCC process that can function as both low-carbon olefins additive to increase olefins yield and slurry additive to reduce slurry yield. To simultaneously produce more low-carbon olefins and reduce slurry, an attempt has been made by blending low-carbon olefins-additive and slurry additive. However, blending two different additives with different functions creates interference between the low-carbon olefins additive and the slurry additive and the currently used additive to produce more low-carbon olefins mainly comprises of phosphorus-alumina binder where the phosphorus element in such additive is easy to spread onto the main catalyst as well on the other additive during reaction, thereby causing decrease in activity of the catalyst. It has been noted that when low-carbon olefins additive and slurry additive blend is used, slurry yield in product is even increased. Moreover, low-carbon olefins additives generally have specific surface areas less than 180 m²/g, while slurry additives have minimum specific surface areas greater than 190 m²/g. Adding both additives (equal amounts) to FCC catalyst doubly dilutes active catalyst and the phosphorous and its low surface area of the low-carbon olefins additive inhibits the function of the slurry reducing additive. In the present invention, a bifunctional additive with both producing more low-carbon olefins function and reducing slurry function is characterized by its open channels with specific surface area greater than 190 m²/s, thereby good performance on producing more low-carbon olefins and less slurry is achieved.

### Technical Solution

The first purpose of the invention is to provide a bifunctional additive to simultaneously produce more low-carbon olefins and reduce slurry. The said additive is able, in the FCC process, to increase production rate of cracked LPG, concentration of propylene in LPG and octane number of so produced gasoline, and to reduce slurry yield in cracking products.

To achieve the said purpose, the invention provides the following technical solution: assembling a bifunctional additive to produce more low-carbon olefins and reduce slurry, wherein the dry-basis composition of the said additive is composed of: 40˜55 wt % of phosphorus-containing MFI zeolite, 0˜10 wt % of large pore zeolites, 3˜20 wt % of inorganic binder, 8˜22 wt % of inorganic matrix composed of alumina and/or amorphous alumina-silica and 15˜40 wt % of clay, and preferably, 45˜50 wt % of phosphorus-containing MFI zeolite, 0˜5 wt % of large pore type Y and/or Beta zeolite, 10˜15 wt % of inorganic binder, 8˜12 wt % of inorganic matrix composed of alumina and/or amorphous alumina-silica and 20˜30 wt % of clay.

The said bifunctional additive has a specific surface area of greater than 190 m²/g and a P₂O₅ content of less than 2 wt %.

The molar ratio of SiO₂/Al₂O₃ of the said phosphorus-containing MFI zeolite is 10˜50, and the content of P₂O₅ in the zeolite is 1˜5 wt %, and preferably, the SiO₂/Al₂O₃ molar ratio of the said phosphorus-containing MFI zeolite is 20˜40, and the content of P₂O₅ in the zeolite is 2˜4 wt %.

Phosphorus element in the said phosphorus-containing MFI zeolite can be introduced during the MFI synthesis, or by impregnating MFI zeolite with phosphoric acid or phosphate solutions.

The said large pore zeolite is of Y type zeolite and/or Beta type zeolite.

The said Y type zeolite is of rare earth-modified Y type zeolite, phosphorus-modified Y type zeolite, rare earth- and phosphorus-modified Y type zeolite, ultra-stable Y type zeolite and/or rare earth-modified ultra-stable Y type zeolite.

The said inorganic binder is of alumina binder, silica binder and/or alumina-silica binder.

The said inorganic matrix is of calcined alumina and/or amorphous alumina-silica with total specific surface area more than 200 m²/g.

The said clay is of kaolinite, montmorillonite, attapulgite, diatomite and/or sepiolite.

The second purpose of the invention is to provide a making method of the bifunctional additive which comprises the following steps of: first spray-drying with phosphorus-containing MFI zeolite, large pore zeolites, inorganic binder, inorganic matrix composed of alumina and/or amorphous alumina-silica and clay, and then calcining the spray-dried materials at 450° C.˜750° C. for 0.1˜10 h.

It shall be noted that the bifunctional additive in the invention can be made using universal method. There is no special restrictions on making method of the bifunctional additive. The universal method available for making additive comprises the following steps of: adding zeolite, matrix, binder and clay as the main ingredients to deionized water, blending them to form suspension slurry with a solid content of 20˜50 wt %, and then spray-drying the suspension slurry.

Preferably, the calcining temperature is 500˜600° C., and the calcining time is 1˜3 h.

The steps for spray-drying include: mixing and blending phosphorus-containing MFI zeolite, large pore zeolites, inorganic binder, inorganic matrix, clay and water in one or more steps to make suspension slurry, and then spray-drying the suspension slurry.

The third purpose of the invention is to test the said bifunctional additive to produce more low-carbon olefins and to reduce slurry during catalytic cracking reaction using various feed oils such as atmospheric residue, vacuum residue, atmospheric gas oil, vacuum gas oil, straight-run gas oil and/or coker gas oil.

The testing conditions for the bifunctional additive for FCC process in the invention are the normal catalytic cracking reaction conditions. Generally, temperature for such catalytic cracking reaction is 450˜650° C., and catalyst/oil ratio is 4˜15, and preferably, temperature is 490˜600° C. and catalyst/oil ratio is 4˜15.

The mass proportion of the said bifunctional additive to total catalyst in the FCC unit is 1˜30 wt %, preferably 5˜15 wt %.

### Beneficial Effects

The bifunctional additive provided in the invention is used in FCC process to increase production rate of cracked product LPG, yield of propylene in LPG, octane number of cracked product gasoline and to reduce slurry yield of cracking products. The invention also discloses the preparation method and application of the said additive.

### MOST PREFERRED EMBODIMENTS OF THE INVENTION

Impregnating and flash drying H-ZSM-5 (molar ratio of SiO₂/Al₂O₃ is 27) with ammonium di-hydrogen phosphate, and then calcining the flash dried material at 500° C. for 2 h to obtain phosphorus-containing ZSM-5 zeolite, wherein P₂O₅ content in the zeolite is 2.7 wt %.

Add 4 kg (dry-basis) phosphorus-containing ZSM-5 zeolite and 1 kg (dry-basis) rare earth-modified ultra-stable Y type zeolite (SiO₂/Al₂O₃ molar ratio is 9, and content of RE₂O₃ is 8 wt %) to 5.5 kg deionized water, and stir at high speed for 30 min to obtain phosphorus-containing MFI zeolite suspension.

Add 2.6 kg (dry-basis) kaolinite to 6 kg deionized water while stirring, and stir at high speed for 2 h. Wait for the kaolinite to be completely dispersed in the suspension, and then add 1 kg (dry-basis) of pseudo-boehmite. Adjust pH of the suspension to 2.5˜3.5 with HCl, so that the pseudo-boehmite can experience a gelation reaction. After stirring for 30 min, add 1.4 kg (dry-basis) silicon-alumina binder (with 30 wt % of SiO₂ and 3 wt % of Al₂O₃). Stir for 30 min, and then add the said zeolite suspension. Keep blending for 30 min until the solid content of the final suspension slurry obtained is 41 wt %. Homogenize the suspension slurry before spray-drying, and then calcine the spray-dried material at 550° C. for 2 h. Bifunctional additive LOBC-5 for producing more low-carbon olefins and reducing slurry is then obtained.

The bifunctional additive LOBC-5 has an abrasion index of 1.2 wt %/h, a specific surface area of 213 m²/g and a P₂O₅ content of 1.08 wt %. After passivation with metal and steam treatment, add 15 wt % the treated additive to a selected FCC equilibrium catalyst (FCC e-cat). Cracking performance testing result of the mixed catalyst is shown in Table 3.

### Comparative Example and Embodiments

The followings further describe the claims of the invention in details by means of comparative examples and specific embodiments, but with no restrictions.

In the following embodiments and comparative examples, specific surface areas of catalysts are determined by using the BET low-temperature nitrogen adsorption method, elements and compositions of catalysts are measured with X-ray fluorescence spectrophotometer and abrasion index of catalysts are obtained with abrasion index analyzer.

### Comparative Example 1

Add 3.6 kg (dry-basis) kaolinite and 1.4 kg (dry-basis) alumina sol to 5 kg deionized water while stirring, and continuously stir at high speed for 2 h. Wait for the kaolinite to be completely dispersed in the suspension, and then add 1 kg (dry-basis) pseudo-boehmite (with a specific surface area of 240 m²/g, same below). Adjust pH of the suspension to 2.5˜3.5 with HCl, so that the pseudo-boehmite can experience a gelation reaction. Stir for 30 min and then add a zeolite suspension prepared with 4 kg (dry-basis) H-ZSM-5 zeolite (molar ratio of SiO₂/Al₂O₃ is 27) and 4.5 kg deionized water. Keep blending for 30 min until the solid content of the suspension slurry obtained is 40 wt %. Homogenize the suspension slurry before spray-drying, and then calcine the spray-dried material at 550° C. for 2 h. Comparative additive C-1 is obtained.

The comparative additive C-1 has an abrasion index of 1.2 wt %/h, a specific surface area of 178 m²/g and a P₂O₅ content of 0 wt %. After passivation with metal and steam treatment, add 15 wt % the treated additive to the selected FCC e-cat. Cracking performance testing result of the mixed catalyst is shown in Table 3.

### Comparative Example 2

Disperse 0.75 kg (dry-basis) pseudo-boehmite in 1.2 kg deionized water while stirring, and then slowly add 4 kg concentrated phosphoric acid (containing 85 wt % of H₃PO₄); stir at 60° C. until the solution becomes transparent, phosphorus-alumina binder is obtained. Add 5.5 kg (dry-basis) kaolinite to 20 kg deionized water, and stir at high speed for 2 h. Wait for the kaolinite to be completely dispersed in the suspension, and then add 0.75 kg (dry-basis) alumina sol binder and the above prepared phosphorus-alumina binder. Stir for 30 min and then add a zeolite suspension prepared with 5 kg (dry-basis) H-ZSM-5 zeolite (molar ratio of SiO₂/Al₂O₃ is 27) and 6 kg deionized water. Keep blending for 30 min to form a suspension slurry. Homogenize the suspension slurry before spray-drying, and then calcine the spray-dried material at 550° C. for 2 h. Comparative additive C-2 is then obtained.

The comparative additive C-2 has an abrasion index of 6.2 wt %/h, a specific surface area of 81 m²/g and a P₂O₅ content of 17.11 wt %. After passivation with metal and steam treatment, add 15 wt % the treated additive to the selected FCC e-cat. Cracking performance testing result of the mixed catalyst is shown in Table 3.

### Comparative Example 3

Add 2.5 kg (dry-basis) pseudo-boehmite and 1 kg (dry-basis) REY zeolite (molar ratio of SiO₂/Al₂O₃ is 5, and content of RE₂O₃ is 8 wt %) to 10 kg deionized water while stirring. Stir for 30 min, a suspension with zeolite and pseudo-boehmite is obtained.

Add 3.7 kg (dry-basis) kaolinite to 14 kg deionized water while stirring, and stir at highspeed for 2 h. Wait for the kaolinite to be completely dispersed in the suspension, and then add 2 kg (dry-basis) pseudo-boehmite. Adjust pH of the suspension to 2.5 with HCl, so that the pseudo-boehmite can experience a gelation reaction. Stir for 30 min and then add 2 kg acidic silica sol solution (containing 40 wt % of SiO₂). Stir for 20 min and then add the prepared mixture suspension of zeolite and pseudo-boehmite. Keep blending for 30 min until the solid content of the suspension slurry obtained is 25 wt %. Homogenize the suspension slurry before spray-drying, and then calcine the spray-dried material at 550° C. for 2 h. Comparative additive C-3 is obtained.

The comparative additive C-3 has an abrasion index of 1.1 wt %/h, a specific surface area of 284 m²/g and a P₂O₅ content of 0 wt %. After passivation with metal and steam treatment, add 15 wt % the treated additive to the selected FCC e-cat and then the mixture catalyst is catalytic cracking tested. Cracking performance testing result is shown in Table 3.

### Embodiment 1

Impregnating and flash drying H-ZSM-5 zeolite (SiO₂/Al₂O₃ molar ratio is 27) with ammonium di-hydrogen phosphate, and then the flash dried zeolite is calcined at 550° C. for 2 h to obtain phosphorus-containing ZSM-5 zeolite, wherein P₂O₅ content in the prepared zeolite is 3.2 wt %.

Add 5 kg (dry-basis) phosphorus-containing ZSM-5 zeolite to 5.5 kg deionized water, and stir at high speed for 30 min. A phosphorus-containing MFI zeolite suspension is obtained.

Add 2.6 kg (dry-basis) kaolinite and 1.4 kg (dry-basis) alumina sol to 4 kg deionized water while stirring, and stir at high speed for 2 h. Wait for the kaolinite to be completely dispersed in the suspension, and then add 1 kg (dry-basis) pseudo-boehmite. Adjust pH of the suspension to 2.5˜3.5 with HCl, so that the pseudo-boehmite can experience a gelation reaction. Stir for 30 min, and then add the prepared zeolite suspension. Keep blending for 30 min until the solid content of the suspension slurry obtained is 41 wt %. Homogenize the suspension slurry before spray-drying, and then the spray-dried material is calcined at 550° C. for 2 h. Additive LOBC-1 is obtained.

The additive LOBC-1 has an abrasion index of 1.2 wt %/h, a specific surface area of 196 m²/g and a P₂O₅ content of 1.47 wt %. After passivation with metal and steam treatment, add 15 wt % the treated additive to the selected FCC e-cat. Cracking performance testing result of the mixed catalyst is shown in Table 3.

### Embodiment 2

Impregnating and flash drying H-ZSM-5 (molar ratio of SiO₂/Al₂O₃ is 27) with ammonium di-hydrogen phosphate, and then calcine the flash dried zeolite at 500° C. for 2 h. Phosphorus-containing ZSM-5 zeolite is obtained, wherein P₂O₅ content in the zeolite is 2.8 wt %.

Add 5.5 kg (dry-basis) phosphorus-containing ZSM-5 zeolite to 6 kg deionized water, and stir at high speed for 30 min. The phosphorus-containing MFI zeolite suspension is obtained.

Add 2.4 kg (dry-basis) kaolinite and 1.3 kg (dry-basis) alumina sol to 3.5 kg deionized water while stirring, and stir at high speed for 1 h. Wait for the kaolinite to be completely dispersed in the suspension, and then add 0.8 kg (dry-basis) pseudo-boehmite. Adjust pH of the suspension to 2.5˜3.5 with HCl, so that the pseudo-boehmite can experience a gelation reaction. Stir for 30 min, and then add the zeolite suspension. Keep blending for 30 min until the solid content of the suspension slurry obtained is 41 wt %. Homogenize the suspension slurry before spray-drying, and then calcine the spray-dried material at 500° C. for 3 h. Additive LOBC-2 to both produce more low-carbon olefins and reduce slurry is obtained.

The additive LOBC-2 has an abrasion index of 0.5 wt %/h, a specific surface area of 205 m²/g and a P₂O₅ content of 1.54 wt %. After passivation with metal and steam treatment, add 15 wt % the treated additive to the selected FCC e-cat. Cracking performance testing result of the mixed catalyst is shown in Table 3

### Embodiment 3

Impregnating and flash drying H-ZSM-5 (molar ratio of SiO₂/Al₂O₃ is 29) with ammonium di-hydrogen phosphate, and then calcine the flash dried zeolite at 500° C. for 2 h. Phosphorus-containing ZSM-5 zeolite is obtained, wherein P₂O₅ content in the zeolite is 2 wt %.

Add 4 kg (dry-basis) phosphorus-containing ZSM-5 zeolite and 0.9 kg (dry-basis) rare earth- and phosphorus-modified Y type zeolite (molar ratio SiO₂/Al₂O₃ is 5, RE₂O₃ is 4 wt % and P₂O₅ is 1 wt %) to 5.5 kg deionized water, and stir at high speed for 30 min. A phosphorus-containing MFI zeolite suspension is obtained.

Add 2.6 kg (dry-basis) montmorillonite and 0.3 kg (dry-basis) alumina sol to 4 kg deionized water while stirring, and stir at high speed for 2 h. Wait for the montmorillonite to be completely dispersed in the suspension, and then add 2.2 kg (dry-basis) pseudo-boehmite. Adjust pH of the suspension to 2.5˜3.5 with HCl, so that the pseudo-boehmite can experience a gelation reaction. Stir for 30 min and then add 0.3 kg (dry-basis) acidic silica sol (containing 40 wt % of SiO₂). Stir for 30 min, and then add the zeolite suspension. Keep blending for 30 min until the solid content of the suspension slurry obtained is 40 wt %. Homogenize and grind the suspension slurry before spray-drying, and then calcine the spray-dried material at 500° C. for 2 h. Additive LOBC-3 for both producing more low-carbon olefins and reducing slurry is obtained.

The additive LOBC-3 has an abrasion index of 2.1 wt %/h, a specific surface area of 226 m²/g and a P₂O₅ content of 0.89 wt %. After passivation with metal and steam treatment, add 15 wt % the treated additive to the selected FCC e-cat. Cracking performance testing result of the mixed catalyst is shown in Table 3

### Embodiment 4

Impregnating and flash drying H-ZSM-5 (molar ratio of SiO₂/Al₂O₃ is 10) with ammonium di-hydrogen phosphate, and then calcine the flash dried zeolite at 500° C. for 2 h. The phosphorus-containing ZSM-5 zeolite is obtained, wherein P₂O₅ content in the zeolite is 5 wt %.

Add 4 kg (dry-basis) phosphorus-containing ZSM-5 zeolite and 1 kg (dry-basis) ultra-stable Y type zeolite (molar ratio of skeleton SiO₂/Al₂O₃ is 9) to 5.5 kg deionized water, and stir at high speed for 30 min. A phosphorus-containing MFI zeolite suspension is obtained.

Add 2.6 kg (dry-basis) attapulgite to 6 kg deionized water while stirring, and stir at high speed for 2 h. Wait for the attapulgite to be completely dispersed in the suspension, and then add 1 kg (dry-basis) pseudo-boehmite. Adjust pH of the suspension to 2.5˜3.5 with HCl, so that the pseudo-boehmite can experience a gelation reaction. Stir for 30 min and then add 1.4 kg (dry-basis) acidic silica sol (containing 40 wt % of SiO₂). Stir for 30 min, and then add the zeolite suspension. Keep blending for 30 min until the solid content of the suspension slurry obtained is 41 wt %. Homogenize the suspension slurry before spray-drying, and then calcine the spray-dried suspension at 550° C. for 2 h. Additive LOBC-4 for both producing more low-carbon olefins and reducing slurry is then obtained.

The additive LOBC-4 has an abrasion index of 0.9 wt %/h, a specific surface area of 208 m²/g and a P₂O₅ content of 2 wt %. After passivation with metal and steam treatment, add 15 wt % the treated additive to the selected FCC e-cat. Cracking performance testing result of the mixed catalyst is shown in Table 3

### Embodiment 5

Impregnating and flash drying H-ZSM-5 (molar ratio of SiO₂/Al₂O₃ is 50) with ammonium di-hydrogen phosphate, and then calcine the flash dried zeolite at 500° C. for 2 h. The phosphorus-containing ZSM-5 zeolite is obtained, wherein P₂O₅ content in the zeolite is 1 wt %.

Add 4 kg (dry-basis) phosphorus-containing ZSM-5 zeolite and 1 kg (dry-basis) P-modified Y type zeolite (SiO₂/Al₂O₃ is 5, and P₂O₅ is 1 wt %) to 5.5 kg deionized water, and stir at high speed for 30 min. A phosphorus-containing MFI zeolite suspension is obtained.

Add 2 kg (dry-basis) sepiolite and 2 kg (dry-basis) alumina sol to 4 kg deionized water while stirring, and stir at high speed for 2 h. Wait for the sepiolite to be completely dispersed in the suspension, and then add 1 kg (dry-basis) ground amorphous alumina-silica (with a specific surface area of 289 m²/g). Stir for 30 min, and then add the zeolite suspension. Keep blending for 30 min until the solid content of the suspension slurry obtained is 41 wt %. Homogenize the size before spray-drying, and then calcine the spray-dried material at 750° C. for 0.1 h. Additive LOBC-6 for both producing more low-carbon olefins and reducing slurry is obtained.

The additive LOBC-6 has an abrasion index of 0.9 wt %/h, a specific surface area of 221 m²/g and a P₂O₅ content of 0.5 wt %. After passivation with metal and steam treatment, add 15 wt % the treated additive to the selected FCC e-cat. Cracking performance testing result of the mixed catalyst is shown in Table 3

### Embodiment 6

Impregnating and flash drying H-ZSM-5 (molar ratio of SiO₂/Al₂O₃ is 27) with ammonium di-hydrogen phosphate, and then calcine the flash dried zeolite at 500° C. for 2 h. The phosphorus-containing ZSM-5 zeolite is obtained, wherein P₂O₅ content in the zeolite is 3.2 wt %.

Add 4 kg (dry-basis) phosphorus-containing ZSM-5 zeolite and 1 kg (dry-basis) rare earth Y type zeolite (molar ratio of SiO₂/Al₂O₃ is 5, and content of RE₂O₃ is 4 wt %) to 5.5 kg deionized water, and stir at high speed for 30 min. A phosphorus-containing MFI and Y zeolites suspension is obtained.

Add 2.6 kg (dry-basis) kaolinite and 1.4 kg (dry-basis) alumina sol to 4 kg deionized water while stirring, and stir at high speed for 2 h. Wait for the kaolinite to be completely dispersed in the suspension, and then add 1 kg (dry-basis) pseudo-boehmite. Adjust pH of the suspension to 2.5˜3.5 with HCl, so that the pseudo-boehmite can experience a gelation reaction. Stir for 30 min, and then add the zeolite suspension. Keep blending for 30 min until the solid content of the suspension slurry obtained is 41 wt %. Homogenize the suspension before spray-drying, and then calcine the spray dried material at 550° C. for 2 h. Additive LOBC-7 for both producing more low-carbon olefins and reducing slurry is obtained.

The additive LOBC-7 has an abrasion index of 0.8 wt %/h, a specific surface area of 217 m²/g and a P₂O₅ content of 1.28 wt %. After passivation with metal and steam treatment, add 15 wt % the treated additive to the selected FCC e-cat. Cracking performance testing result of the mixed catalyst is shown in Table 3.

### Embodiment 7

Impregnating and flash drying H-ZSM-5 (molar ratio of SiO₂/Al₂O₃ is 27) with ammonium di-hydrogen phosphate, and then calcine the spray dried zeolite at 500° C. for 2 h. The phosphorus-containing ZSM-5 zeolite is obtained, wherein P₂O₅ content in the zeolite is 3.2 wt %.

Add 4 kg (dry-basis) phosphorus-containing ZSM-5 zeolite and 1 kg (dry-basis) Beta type zeolite (molar ratio of SiO₂/Al₂O₃ is 20) to 5.5 kg deionized water, and stir at high speed for 30 min. A phosphorus-containing MFI and Beta zeolites suspension is obtained.

Add 2.6 kg (dry-basis) kaolinite and 1.4 kg (dry-basis) alumina sol to 4 kg deionized water while stirring, and stir at a high speed for 2 h. Wait for the kaolinite to be completely dispersed in the suspension, and then add 1 kg (dry-basis) pseudo-boehmite. Adjust pH of the suspension to 2.5˜3.5 with HCl, so that the pseudo-boehmite can experience a gelation reaction. Stir for 30 min, and then add the zeolite suspension. Keep blending for 30 min until the solid content of the suspension slurry obtained is 41 wt %. Homogenize the size before spray-drying, and then calcine the spray-dried material at 550° C. for 2 h. Additive LOBC-8 for both producing more low-carbon olefins and reducing slurry is obtained.

The additive LOBC-8 has an abrasion index of 1.3 wt %/h, a specific surface area of 204 m²/g and a P₂O₅ content of 1.28 wt %. After passivation with metal and treatment, add 15 wt % the treated additive to the selected FCC e-cat. Cracking performance testing result of the mixed catalyst is shown in Table 3.

### Embodiment 8

Impregnating and flash drying H-ZSM-5 (molar ratio of SiO₂/Al₂O₃ is 27) with phosphoric acid, and then calcine the flash dried zeolite at 500° C. for 2 h. The phosphorus-containing ZSM-5 zeolite is obtained, wherein P₂O₅ content in the zeolite is 3.2 wt %.

Add 4 kg (dry-basis) phosphorus-containing ZSM-5 zeolite and 1 kg (dry-basis) rare earth ultra-stable Y type zeolite (SiO₂/Al₂O₃ is 9, and RE₂O₃ is 4 wt %) to 5.5 kg deionized water, and stir at high speed for 30 min. A phosphorus-containing MFI and Y zeolites suspension is obtained.

Add 2.6 kg (dry-basis) kaolinite and 1.4 kg (dry-basis) alumina sol to 4 kg deionized water while stirring, and stir at high speed for 2 h. Wait for the kaolinite to be completely dispersed in the suspension, and then add 1 kg (dry-basis) pseudo-boehmite. Adjust pH of the suspension to 2.5˜3.5 with HCl, so that the pseudo-boehmite can experience a gelation reaction. Stir for 30 min, and then add the zeolite suspension. Keep blending for 30 min until the solid content of the suspension slurry obtained is 41 wt %. Homogenize the suspension slurry before spray-drying, and then calcine the spray dried material at 550° C. for 2 h. Additive LOBC-9 for both producing more low-carbon olefins and reducing slurry is obtained.

The additive LOBC-9 has an abrasion index of 0.7 wt %/h, a specific surface area of 218 m²/g and a P₂O₅ content of 1.28 wt %. After passivation with metal and treatment, add 15 wt % the treated additive to the selected FCC e-cat. Cracking performance testing result of the mixed catalyst is shown in Table 3.

### Embodiment 9

Impregnating and flash drying H-ZSM-5 (SiO₂/Al₂O₃ is 27) with phosphoric acid, and then calcine the flash dried zeolite at 500° C. for 2 h. The phosphorus-containing ZSM-5 zeolite is obtained, wherein P₂O₅ content in the zeolite is 5 wt %.

Add 4 kg (dry-basis) phosphorus-containing ZSM-5 zeolite and 1 kg (dry-basis) rare earth ultra-stable Y type zeolite (SiO₂/Al₂O₃ is 9, and RE₂O₃ is 4 wt %) into 5.5 kg deionized water, and stir at high speed for 30 min. A phosphorus-containing MFI and Y zeolites suspension is obtained.

Add 2.6 kg (dry-basis) kaolinite and 1.4 kg (dry-basis) alumina sol to 4 kg deionized water while stirring, and stir at high speed for 2 h. Wait for the kaolinite to be completely dispersed in the suspension, and then add 1 kg (dry-basis) pseudo-boehmite. Adjust pH of the suspension to 2.5˜3.5 with HCl, so that the pseudo-boehmite can experience a gelation reaction. Stir for 30 min, and then add the zeolite suspension. Keep blending for 30 min until the solid content of the suspension slurry obtained is 41 wt %. Homogenize the suspension before spray-drying, and then calcine the spray-dried material at 550° C. for 2 h. Additive LOBC-10 for both producing more low-carbon olefins and reducing slurry is obtained.

The additive LOBC-10 has an abrasion index of 0.6 wt %/h, a specific surface area of 217 m²/g and a P₂O₅ content of 2 wt %. After passivation with metal and treatment, add 15 wt % the treated additive to the selected FCC e-cat. Cracking performance testing result of the mixed catalyst is shown in Table 3.

### Embodiment 10

Impregnating and flash drying H-ZSM-5 (SiO₂/Al₂O₃ is 27) in sequence with rare-earth salt and ammonium di-hydrogen phosphate, and then calcine the flash dried zeolite at 500° C. for 2 h. The phosphorus- and rare earth-containing ZSM-5 zeolite is obtained, wherein P₂O₅ content in the zeolite is 3.2 wt %, and RE₂O₃ content is 1.8 wt %.

Add 4 kg (dry-basis) phosphorus- and rare earth-containing ZSM-5 zeolite and 1 kg (dry-basis) rare earth ultra-stable Y type zeolite (SiO₂/Al₂O₃ is 9, and RE₂O₃ is 4 wt %) to 5.5 kg deionized water, and stir at high speed for 30 min. A phosphorus-containing MFI and Y zeolites suspension is obtained.

Add 2.5 kg (dry-basis) kaolinite and 1.5 kg (dry-basis) alumina sol to 4 kg deionized water while stirring, and stir at high speed for 2 h. Wait for the kaolinite to be completely dispersed in the suspension, and then add 1 kg (dry-basis) pseudo-boehmite. Adjust pH of the suspension to 2.5˜3.5 with HCl, so that the pseudo-boehmite can experience a gelation reaction. Stir for 30 min, and then add the zeolite suspension. Keep blending for 30 min until the solid content of the suspension slurry obtained is 41 wt %. Homogenize the suspension slurry before spray-drying, and then calcine the spray-dried material at 550° C. for 2 h. Additive LOBC-11 for both producing more low-carbon olefins and reducing slurry is obtained.

The additive LOBC-11 has an abrasion index of 0.6 wt %/h, a specific surface area of 212 m²/g and a P₂O₅ content of 1.28 wt %. After passivation with metal and steam treatment, add 15 wt % the treated additive to the selected FCC e-cat. Cracking performance testing result of the mixed catalyst is shown in Table 3.

In the said embodiments and comparative examples above, catalytic cracking reaction is assessed with miniature fluidized bed reactor (ACE) and supporting gas chromatography, while research octane number (RON) is analyzed with Agilent gas chromatography 7980A. For catalytic cracking test, an industrial FCC e-cat is chosen as main catalyst, the additive is impregnated with 4000 ppm V and 2000 ppm Ni, and then 100% steam aged at 810° C. for 10 h. The catalyst contains 85 wt % FCC e-cat and 15% the deactivated additive. The catalytic cracking reaction temperature is 540° C., oil feeding rate is 1.2 g/min, oil feeding time is 1.5 min and catalyst/oil ratio is 5. For other physicochemical analysis, refer to the National Standard of Method for Test of Petroleum and Petroleum Products (Standards Press of China, 1989).

The main physicochemical properties of FCC e-cat are shown in Table 1, and the properties of feed are given in Table 2. The catalytic cracking performance testing data with 85 wt % of FCC e-cat+15 wt % of deactivated additive in embodiments and comparative examples are shown in Table 3.

TABLE 1
Main Physicochemical Properties of the FCC e-cat

| Item | | Result |
|---|---|---|
| La₂O₃, wt % (m) | | 2.43 |
| CeO₂, wt % (m) | | 1.23 |
| Al₂O₃, wt % (m) | | 52.23 |
| Fe₂O₃, (ppm) | | 4968 |
| Na₂O, (ppm) | | 1761 |
| P₂O₅, wt % (m) | | 1.03 |
| NiO, (ppm) | | 4663 |
| V₂O₅, (ppm) | | 10347 |
| Specific surface area (m²/g) | | 96 |
| Microreactor activity (wt % (m)) | | 56.3 |
| Particle | 0~20 μm, wt % | 0.00 |
| size | 0~40 μm, wt % | 4.2 |
| distribution | 0~80 μm, wt % | 59.4 |
| | 0~105 μm, wt % | 84.2 |
| | 0~149 μm, wt % | 98.8 |
| | D₅₀, μm | 73.3 |

TABLE 2
Properties of Feed

| Item | Result |
|---|---|
| Density, 15 degC., kg/m³ | 903 |
| Sulfur content, ppmw | 610 |
| Nitrogen content, ppmw | 180 |

Distillation range (Deg C.) ASTM D-1160

| | |
|---|---|
| 15 wt % | 332° C. |
| 10 wt % | 352° C. |
| 30 wt % | 401° C. |
| 50 wt % | 448° C. |
| 70 wt % | 505° C. |
| 90 wt % | 552° C. |
| 95 wt % | 575° C. |
| H element content (wt %) | 12.4 |
| Ni, ppmw | 7.8 |
| V, PPmw | 16.2 |
| Fe, ppmw | 4.0 |
| Na, ppmw | 4.6 |
| Residual carbon (wt %) | 4.6 |

TABLE 3
Performance of Catalytic Cracking of Samples in
Embodiments and Comparative Examples

| | | Yield | Yield | | Yield of |
|---|---|---|---|---|---|
| | Con- | of | of | Yield of | gasoline + |
| | version | slurry, | coke, | propylene, | LPG, |
| Additive | wt % | wt % | wt % | wt % | wt % |
| No additive | 73.20 | 9.38 | 8.13 | 4.64 | 62.17 |
| Additive C-1 | 72.23 | 10.31 | 8.04 | 6.01 | 61.32 |
| Additive C-2 | 71.56 | 10.92 | 7.93 | 9.03 | 60.80 |
| Additive C-3 | 73.98 | 9.16 | 8.24 | 4.29 | 62.80 |
| Additive | 73.23 | 9.62 | 8.15 | 9.65 | 62.17 |
| LOBC-1 | | | | | |
| Additive | 73.53 | 9.53 | 8.11 | 9.43 | 62.53 |
| LOBC-2 | | | | | |
| Additive | 73.61 | 9.67 | 8.15 | 8.91 | 62.55 |
| LOBC-3 | | | | | |
| Additive | 73.11 | 9.77 | 8.16 | 10.21 | 62.04 |
| LOBC-4 | | | | | |
| Additive | 74.21 | 8.98 | 8.22 | 9.85 | 63.06 |
| LOBC-5 | | | | | |
| Additive | 73.39 | 9.97 | 8.13 | 8.21 | 63.16 |
| LOBC-6 | | | | | |
| Additive | 73.44 | 9.31 | 8.16 | 9.69 | 62.37 |
| LOBC-7 | | | | | |
| Additive | 73.58 | 9.61 | 8.13 | 9.74 | 62.55 |
| LOBC-8 | | | | | |
| Additive | 73.98 | 9.51 | 8.26 | 9.82 | 62.77 |
| LOBC-9 | | | | | |
| Additive | 73.46 | 9.72 | 8.16 | 9.99 | 62.39 |
| LOBC-10 | | | | | |
| Additive | 73.59 | 9.81 | 8.19 | 10.07 | 62.48 |
| LOBC-11 | | | | | |

The embodiments above are only the preferred embodiments for the invention and not used to restrict the invention. For the technicians of the field, various modifications and changes can be made within the ideas and principles of the invention, and such equivalent changes or replacements are included in the range of protection in the invention.

### INDUSTRIAL APPLICABILITY

The bifunctional additive provided in the invention is used in FCC process to increase production rate of cracked LPG, yield of propylene in LPG and octane number of catalytically cracked gasoline, and to reduce the yield of slurry in the cracking products. Those features of the bifunctional additive are expected to provide wider industrial applications.

What is claimed is:

1. A bifunctional additive of producing more low-carbon olefins and simultaneously reducing slurry, wherein the dry-basis components of said additive is as follows: 40˜55 wt % of phosphorus-containing MFI zeolite, 0˜10 wt % of large pore zeolites, 3˜20 wt % of inorganic binder, 8˜22 wt % of inorganic matrix composed of alumina and amorphous silica-alumina and 15˜40 wt % of clay.

2. The bifunctional additive of producing more low-carbon olefins and simultaneously reducing slurry according to claim 1, wherein the molar ratio of SiO₂/Al₂O₃ of said phosphorus-containing MFI zeolite is 10˜50, and the content of P₂O₅ in the zeolite is 1˜5 wt %.

3. The bifunctional additive of producing more low-carbon olefins and simultaneously reducing slurry according to claim 1, wherein said large pore zeolite is of Y type and/or Beta type zeolites.

4. The bifunctional additive of producing more low-carbon olefins and simultaneously reducing slurry according to claim 3, wherein said Y type zeolite is of rare earth-modified Y type zeolite, phosphorus-modified Y type zeolite, rare earth- and phosphorus-modified Y type zeolite, ultra-stable Y type zeolite and/or rare earth-modified ultra-stable Y type zeolite.

5. The bifunctional additive of producing more low-carbon olefins and simultaneously reducing slurry according to claim 1, wherein said inorganic binder is of alumina binder, silica binder and/or alumina-silica binder.

6. The bifunctional additive of producing more low-carbon olefins and simultaneously reducing slurry according to claim 1, wherein said inorganic matrix is of calcined alumina and/or amorphous alumina-silica, with a total specific surface area of more than 200 m²/g.

7. The bifunctional additive of producing more low-carbon olefins and simultaneously reducing slurry according to claim 1, wherein said clay is of kaolinite, montmorillonite, attapulgite, diatomite and/or sepiolite.
